(19) United States
(12) Patent Application Publication
(10) Pub. No.: US 2005/0150477 A1
(43) Pub. Date: Jul. 14, 2005

(54) Cylinder head of an internal combustion engine

(76) Inventors: Ulrich Rieger, Stuttgart (DE); Manfred Riester, Stuttgart (DE)

Correspondence Address: KLAUS J. BACH, 4407 TWIN OAKS DRIVE, MURRYSVILLE, PA, 15668, US

(21) Appl. No.: 11/032,302

(22) Filed: Jan. 10, 2005

Related U.S. Application Data
(63) Continuation-in-part of application No. PCT/EP03/05685, filed on May 30, 2003.

(30) Foreign Application Priority Data
Jul. 11, 2002 (DE) 102 31 378.4

(51) Int. Cl. F02F 1/00; F01N 7/10

(52) U.S. Cl. 123/193.5; 60/323

(57) ABSTRACT

In a cylinder head of an internal combustion engine having an exhaust passage, a lower cylinder head part, an upper cylinder head part, and a bolt-on surface on the exhaust side with an exhaust manifold bolted thereto, a sealing surface is arranged in a recess extending along the exhaust passage into the cylinder head and the manifold has a tube which extends into the recess in sealing engagement with the sealing surface at the bottom of the recess and which is spaced from the surrounding wall of the cylinder head recess, through which the manifold tube extends in a curved fashion.

This is a Continuation-In-Part Application of International application PCT/EP2003/005685 filed May 30, 2003 and claiming the priority of German application 102 31 378.4 filed Jul. 11, 2002.

### BACKGROUND OF THE INVENTION

The invention relates to a cylinder head of an internal combustion engine having an exhaust manifold mounted thereon.

In internal combustion engines, exhaust manifolds are generally bolted to the cylinder head on a flange surface which is both a bearing surface for a seal and a bolt-on flange of an exhaust manifold. Simple machining of the cylinder head is thereby achieved, since only one continuous surface is machined, that is, the machining takes place along a single plane. Since the bolt-on surface on the cylinder head has to be on the outside of the cylinder head to facilitate machining and because of the space required by the screws for fastening the exhaust manifold and by the cylinder head bolts, the exhaust passages in the cylinder head are relatively long. A long exhaust passage in the cylinder head loses a lot of heat from the exhaust gas to the coolant in the cylinder head since the cylinder head is water-cooled so that there is a lack of heat in the exhaust gas reaching the turbocharger or in devices for the treatment of the exhaust gas.

It is the object of the invention to provide a cylinder head of an internal combustion engine and an exhaust manifold bolted onto the cylinder head, in which as little heat as possible is transferred from the exhaust gas to the engine coolant and the space requirements for the attachment of the exhaust ducts to the cylinder head are reduced.

### SUMMARY OF THE INVENTION

In a cylinder head of an internal combustion engine having an exhaust passage, a lower cylinder head part, an upper cylinder head part, and a bolt-on surface on the exhaust side with an exhaust manifold bolted thereto, a sealing surface is arranged in a recess extending along the exhaust passage into the cylinder head and the manifold has a tube which extends into the recess in sealing engagement with the sealing surface at the bottom of the recess and which is spaced from the surrounding wall of the cylinder head recess, through which the manifold tube extends in a curved fashion.

The intake side and the valve operation sphere are not of significance for the invention. With the arrangement according to the invention the exhaust passage within the cylinder head is shortened as the sealing surface is arranged in the recess in the cylinder head. With this arrangement heat losses to the coolant in the cylinder head are reduced so that, for a turbocharger or a device for the treatment of exhaust gas, hotter exhaust gas is available which has more internal energy. And, with the exhaust duct already curved in the recess less space is required for the arrangement of the exhaust manifold and the flow resistance in the exhaust passage is reduced.

The exhaust passage in the cylinder head is cooled by the cooling liquid of the internal combustion engine, which brings about severe cooling because of the high transfer of heat to the cooling liquid. By contrast, in the exhaust manifold arrangement according to the invention, the manifold inlets are surrounded by air; even an air-gap-insulated manifold may be provided. The loss of heat from the exhaust gas is small in either case. The aim of the invention is to design that section of the overall exhaust-gas duct which is subjected to severe cooling to be as short as possible and to provide the remaining part of the structurally necessary length of the exhaust-gas duct with good insulation, i.e. air, for example. This is achieved by placing the transition from the severely cooled, i.e. liquid-cooled, section to the less severely cooled or insulated section as close as possible to the exhaust valve, but at least upstream of the bolt-on surface of the exhaust manifold. The transition from the severely cooled, i.e. liquid-cooled, section to the less severely cooled or insulated section is designed as a sealing surface on the cylinder head with a seal arranged downstream and a subsequent sealing flange of the exhaust manifold. It is generally not possible for the bolt-on surface of the exhaust manifold to be displaced, since, for stability reasons, the bolt-on flange of the exhaust manifold with the eyes for the fastening bolts requires a certain overall size and since, for space and stability reasons, the position of the fastening bolts in the cylinder head cannot be displaced as desired. For example, the fastening bolts must not intersect any gas or coolant passages and are to be arranged at a sufficient distance from the cylinder head bolts.

In one embodiment of the invention, a cylinder head area extends at least partially around the exhaust manifold, i.e. between the exhaust manifold and the cylinder head there is a narrow gap over part of or over the entire circumference of the exhaust manifold, at least in the region directly downstream of the sealing surface. The narrow gap is formed between the exhaust manifold walls defining the recess receiving flanges and the cylinder head. Because the cylinder head at least partially extends around the exhaust manifold, there is an insulating space in this area, which is filled with air, whereby the loss of heat is reduced. The further the cylinder head fits around it, the better the exhaust manifold is insulated against inadvertent loss of heat.

In a further embodiment of the invention, the threaded bolt bores for fastening the exhaust manifold to the cylinder head are arranged in the lower cylinder head part and in the upper cylinder head part. This ensures a stable and operationally reliable fastening of the exhaust manifold to the cylinder head because, in a conventional design of a cylinder head, the lower cylinder head part and the upper cylinder head part are the most rigid and stable regions of the cylinder head. In an arrangement with the threaded bores, for example, only on the bolt-on surface at the side wall of the cylinder head without further connection to the lower cylinder head part or to the upper cylinder head part, the side wall would easily be deformed when subjected to the weight and heat load of the exhaust manifold. When the threaded bore for fastening the exhaust manifold to the cylinder head is positioned in the lower cylinder head part and in the upper cylinder head part, the forces which act on the fastening bolts because of the weight of the exhaust manifold and, if applicable, the turbocharger fastened thereto and because of the thermal expansion of the exhaust manifold, are accommodated ideally over a large area of the cylinder head.

Conventionally, the center of the exhaust passage extends from the cylinder head first sidewardly but then extends in an approximately right-angled bend to the exhaust manifold and into a common collecting passage. Since, for flow reasons, the bend is designed with a radius which is as large as possible, an arrangement of this type requires a large amount of construction space at the side of the cylinder head. If a subsection of the right-angled bend in the exhaust manifold is in the section upstream of the bolt-on surface, namely between the sealing surface and the bolt-on surface, the rest of the bend section downstream of the bolt-on surface requires less space than a conventional design of a passage where the curvature of the passage has the same radius, since the common collecting passage extends closer to the cylinder head. A curved design of the passage section between the sealing surface and the bolt-on surface is possible without disadvantages in the assembly or in operation, since the direction and curvature of the center of the passage on the bolt-on surface are insignificant, and accordingly the passage can pass through the plane of the bolt-on surface in a curved manner and at any desired angle.

In a further refinement of the invention, the sealing surface and the bolt-on surface of the exhaust passage are aligned in parallel. With a parallel alignment of the two surfaces, the bolt forces do not generate forces during assembly and in the fitted state in the plane of the sealing surface and therefore do not displace the sealing surface of the exhaust manifold in relation to the sealing surface of the cylinder head. An operationally reliable bolt connection is thus possible even in the case of high mechanical and thermal loads.

The invention will become more readily apparent from the following description on the basis of the accompanying drawings, wherein exemplary embodiments of the invention are illustrated in simplified form:

### BRIEF DESCRIPTION OF THE DRAWINGS

FIG. 1 is a side view of a cylinder head according to the invention,

FIG. 2 is a cross-sectional view of a cylinder head according to the invention, and

FIG. 3 is a further cross-sectional view of a cylinder head according to the invention.

### DESCRIPTION OF A PARTICULAR EMBODIMENT

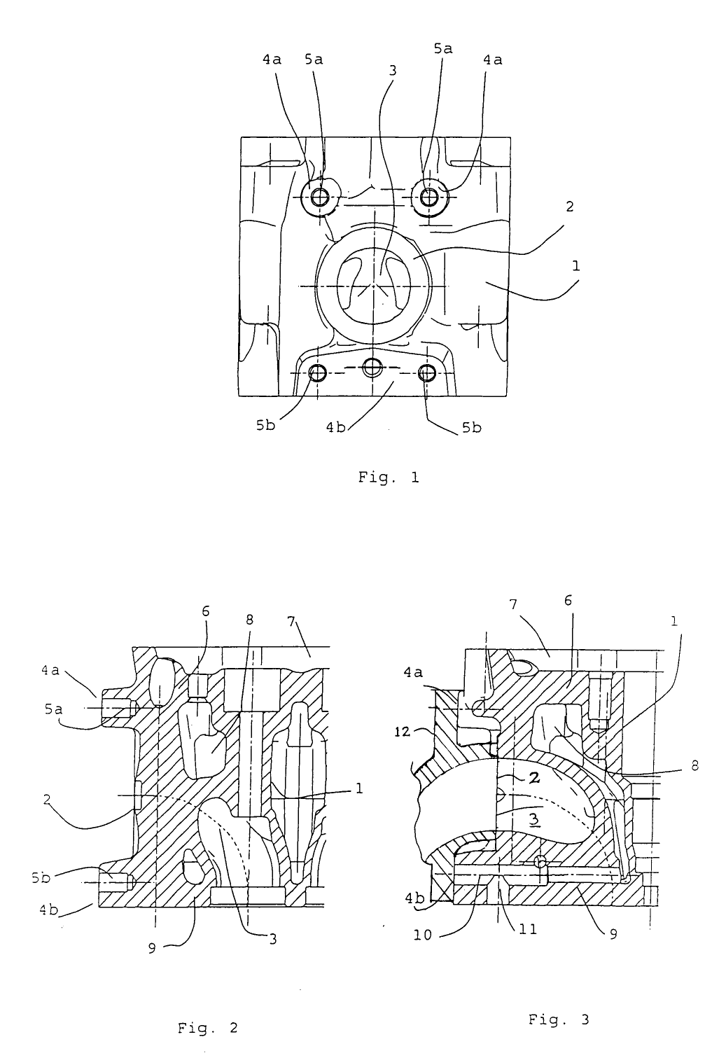

FIG. 1 shows the cylinder head 1 according to the invention in a side view of the exhaust side of a cylinder. In this view, the sealing surface 2 of the exhaust passage 3 and the bolt-on surface 4a, 4b is provided with four threaded bores 5a, 5b for fastening an exhaust manifold 12. The four threaded bores 5a, 5b are distributed as uniformly as possible over the circumference in order at the sealing surface 2 to obtain a uniform loading of a seal (not shown) inserted between the exhaust manifold 12 and the sealing surface 2. Furthermore, the ease of mounting the exhaust manifold and the secure arrangement of the threaded bores 5a, 5b in the cylinder head 1 are taken into account, that is, that sufficient cylinder head material is provided around the sealing surface 2 for accommodating the bores 5a, 5b.

FIG. 2 shows the cylinder head 1 according to the invention in a cross-section passing through a threaded bore 5a, 5b. The sealing surface 2 is displaced parallel in relation to the bolt-on surface 4a, 4b with the threaded bores 5a, 5b, that is, it is recessed upstream into the exhaust passage 3. It can be seen that the axis of the threaded bore 5a extends into the cylinder head top part 6, toward the partition between the oil space 7 and the water space 8 of the cylinder head 1, and the axis of the threaded bore 5b extends into the cylinder head base 9. In this manner, the bolt forces, which are introduced into the cylinder head 1 by the exhaust-manifold bolt connection via the threaded bore 5a, 5b, are ideally absorbed without the cylinder head being deformed.

The sealing surface 2 is displaced as far as possible inwardly in an upstream direction of the exhaust passage 3. A further displacement is not possible because of water passages, oil passages and the bores for the cylinder head bolt connections so that the part of the exhaust passage 3 which outputs heat to the coolant in the water space 8 is small in comparison to a conventional cylinder head. For the same reason, a displacement of the bolt-on surface 4a, 4b and of the threaded bores 5a, 5b is not possible without causing a deterioration in the introduction of forces into the cylinder head.

FIG. 3 shows the cylinder head 1 according to the invention in a cross-section extending perpendicularly with respect to the sealing surface 2 and through the center of the exhaust passage 3. The recessed sealing surface 2 can also be seen clearly here. The bolt-on areas 4a, 4b extend partially around the exhaust manifold 12 in parallel spaced relationship downstream from the sealing surface 2. Also shown is a drilled coolant passage 10 which serves for cooling the valve seat, and a connecting bore 11 to the cylinder block (not shown). Since the connecting bore 11 and the coolant passage 10 must be positioned as permitted by the geometry of the cylinder head, a position of the bolt-on surfaces 4a, 4b closer to the sealing surface 2 or coinciding therewith is not possible or advantageous.

It can be seen both from FIG. 2 and in FIG. 3 that a passage center in an exhaust manifold 12 can be arranged as desired downstream of the sealing surface 2. That is to say, the configuration of a passage of the exhaust manifold 17 can be optimized in respect of large radii of curvature, small constructional space, manufacturing and assembly capabilities or similar criteria.

1. A cylinder head (1) for an internal combustion engine, having an exhaust passage (3), a lower cylinder head part (9) and an upper cylinder head part (6) provided with a bolt-on surface area (4a, 4b) at the exhaust side for the attachment of an exhaust manifold (12), said cylinder head having a recess with a sealing surface (2) arranged at the end of the exhaust passage extending inwardly from the bolt-on surface areas (4a, 4b) such that the cylinder head has wall areas extending at least partially around the exhaust manifold (12), threaded bores (5) for fastening the exhaust manifold (12) arranged in the cylinder bottom part (9) and in the cylinder top part (6), around the manifold (12), the manifold having a passage section between the sealing surface (2) and the bolt-on surface (4a, 4b) which is curved for conducting the exhaust gas smoothly out of the cylinder head.

2. The cylinder head (1) as claimed in claim 1, wherein the bolt-on surface (4a, 4b) and the sealing surface (2) of the exhaust passage are aligned in parallel.
